(19) United States
(12) Patent Application Publication
(10) Pub. No.: US 2007/0006702 A1
(43) Pub. Date: Jan. 11, 2007

(54) Article of manufacture for holding flexible material securely for cutting purposes

(76) Inventor: Kevin Eugene Bernett, Maple Shade, NJ (US)

Correspondence Address: Kevin Eugene Barnett, 25 Gardenia dr., Maple Shade, NJ, 08052, US

(21) Appl. No.: 11/482,333

(22) Filed: Jul. 8, 2006

Related U.S. Application Data
(60) Provisional application No. 60/698,030, filed on Jul. 11, 2005.

(51) Int. Cl. B26D 7/02

(52) U.S. Cl. 83/451; 83/523

(57) ABSTRACT

An article of manufacture used for holding flexible material securely for cutting efficiently, with a base and lid molded of the same material and angled outward at base for the purpose of compressing and spreading tight the material for efficient cutting. A hinge located at one end used for opening above mentioned tool and allowing material to be placed on base. Additions will include a locking feature for permanent closure and storage. There are two identical slots for cutter to penetrate through effortlessly with a flat end of the operating lid for stabilizing the material between the operable pieces. Also included is a slot for measuring devices to be placed for accurate measurements and cut lines.

### CROSS REFERENCE TO RELATED APPLICATIONS

PPA Applic. No. 60/698,030 filed Jul. 11, 2005 confirmation # 1423

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of non-rigid material cutting holders and more specifically to an article of manufacture for holding flexible material securely for cutting purposes.

Insulating is found in every aspect of building both in residential and commercial. Insulating is used for both shielding against heat and securing heat indoors. For most purposes this insulation is mass produced and rolled in lengths and sold per unit or square foot. Insulation is sold for the reason, that during installation various lengths are needed due to different heights of walls and ceilings or lengths of floors. Therefore, various cutting techniques and tools were required to cut to these desired lengths. There have been several different methods and tools that have been developed and patented. Such ways include a foldable table with an enclosed rolling knife with retractable handle. A round knife with a long handle for upright standing while cutting. These have all been developed because of the ineffectiveness of trying to cut insulation. The amount of time that is lost due to trying to cut the insulation by hand which usually results in tearing and ripping, causes inefficient lengths and loss of heat and energy

All these above mentioned tools and accessories do not cut efficiently and eliminate the tearing, and still causes glass fibers to be released into the air to cause respiratory hazards. Generally, these devices have various moving parts and are sophisticated in design, which will come with higher costs in manufacturing and to the consumer.

The shortcomings with these inventions consist of either complicated moving parts proving to be time consuming with learning to operate the tool, or consistent flat surface to allow the product to lay flat and then allow cutter to run across the top of tool. The deficiency in this process is the fact that the material will still slide and remain uncut in various areas therefore disenabling the cutting efficiency.

### BRIEF SUMMARY OF THE INVENTION

The primary advantage of the invention is to reduce possible respiratory hazards by eliminating the tearing which causes certain materials fibers to be released into the air.

Another advantage of the invention is to provide a safe and secure non-rigid material holder that is cost efficient in manufacturing.

A further advantage of the invention is to provide a holder that is simple to understand and operate without multiple instruments

Another advantage of the invention is to provide a holder to be used with various and multiple types of flexible material.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an article of manufacture for holding flexible material, such as fiberglass insulation securely for cutting comprising: a base and lid that are molded at an angle protruding outward from top to bottom to allow insulation to spread tight as it is compressed for non-tearing cutting, therefore reducing respiratory hazards by reducing glass fragments released in to the air, a means for hinging to allow both lid and base to open and close efficiently, a closing feature for permanent closure and storage, slots for cutter to penetrate through with no surface to dull cutter due to the raised slots in the tool, a flat end of the operating member to apply pressure by means of weight by hand or foot, a slot for placing measuring tool for accurate measurements.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a plan view of the preferred flexible material holder

FIG. 2 is a perspective view of the flexible material holding apparatus

FIG. 3 is a cross sectional view of the lid of FIG. 1

FIG. 4 is a magnified view of the lid pin housing of the preferred holder

FIG. 5 is a cross sectional view of the base of FIG. 1

FIG. 6 is a magnified view of the base pin housing in FIG. 1

FIG. 7 is a perspective view of the pin of the apparatus found in FIG. 1

FIG. 8 is a magnified view of the closing hasp feature found on FIG. 1.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

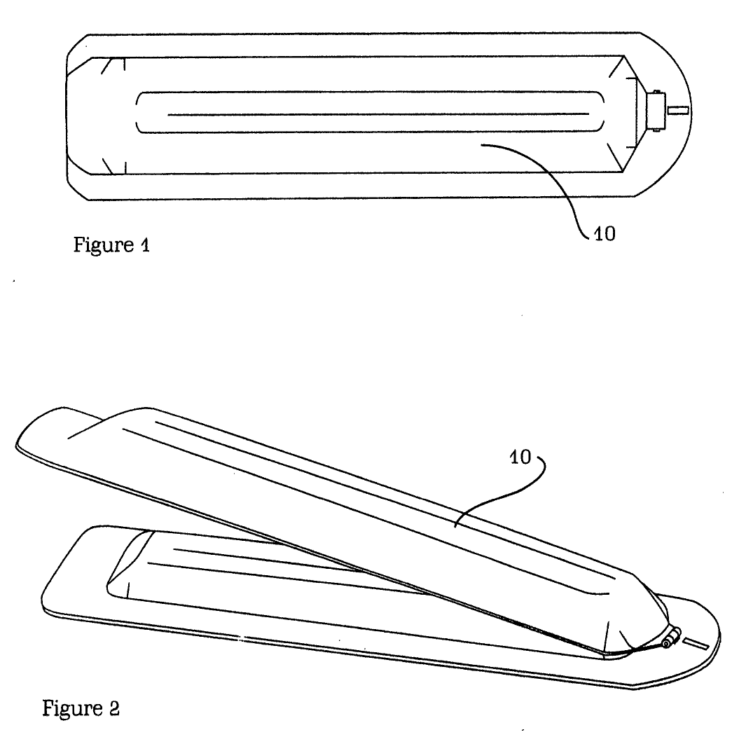

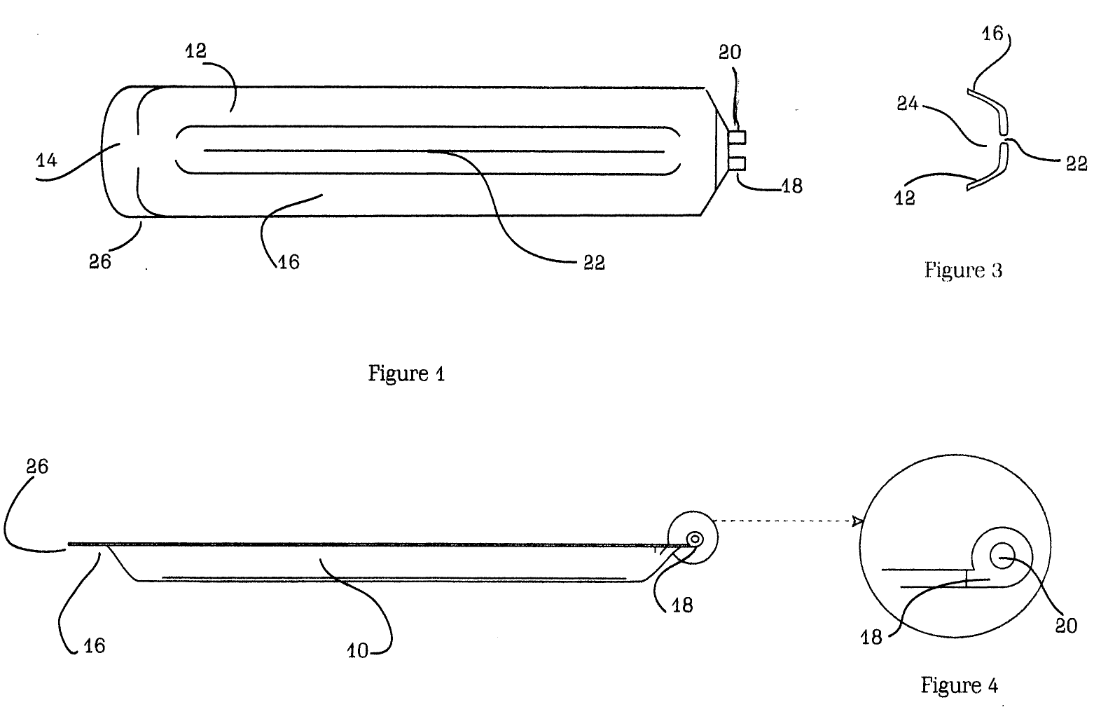

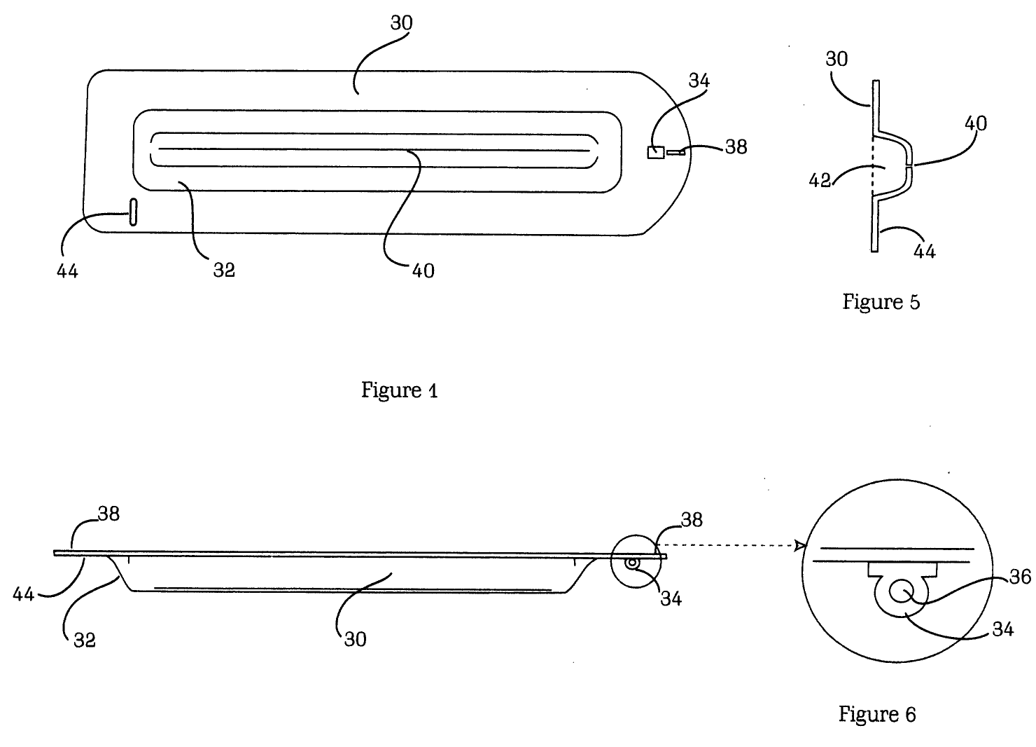

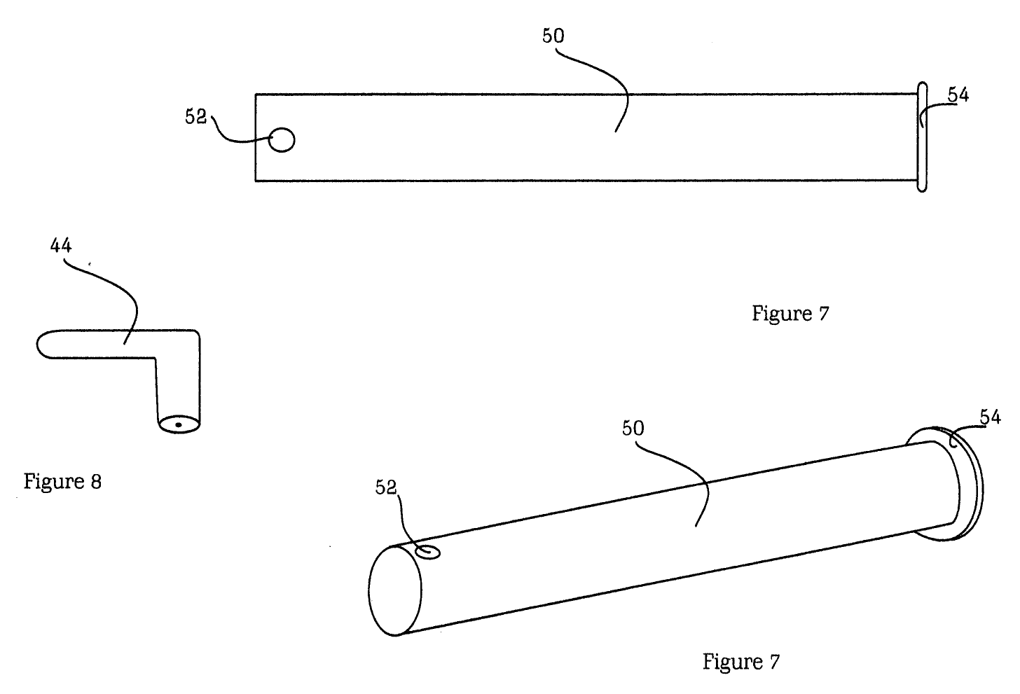

The drawings illustrate a flexible material holding article of manufacture 10 which is the preferred embodiment, to stabilize while in process of cutting. Turning first to FIG. 1 and FIG. 2 there is shown a lid 12 and a base 30 comprised of a single mold in which connected together by round hinge section 18 with an aperture 20 as well as a round hinge section 34 with an aperture 36 molded on base 30 as best shown in FIGS. 4 and 6. As best shown in FIG. 7 a slide pin 50 comprised of a stop flange 54 as well as cotter pin holes 52 slides through said hinges 18 and 34. These form the operating members of this article of manufacture 10. In the particular device illustrated, the lid 12 consists of a extruded angle 16 which, in preferred embodiments, creates a hollow area 24 beneath the lid 12 and base 30 which in accordance with the present invention eliminates surface contact with a cutting apparatus as shown in FIG. 3. The extruded angle 16 comes together at a flat point on top, thus when applying pressure downward on lid 12 over base 30 the material is compressed to a point in which there is no tearing or ripping, This is accomplished in the present instance by pressure applied to a flange step 14 to create the above mentioned tension on material, this is located at the opposite end of the connecting hinge 18 & 34. In the preferred embodiment, this mold is comprised of a continuous groove 22 for a cutting apparatus to penetrate the said material for accurate cutting.

In accordance with the present invention, FIGS. 1 & 2 shows the base 30 In the particular device illustrated, the base 30 consists of a extruded angle 32 which, in preferred embodiments, creates a hollow area 42 beneath the base 30 which in accordance with the present invention eliminates surface contact with a cutting apparatus as best shown in FIG. 5. The extruded angle 32 comes together at a flat point on top, thus when applying pressure downward on above said lid 12, the two grooves 22 and 40 line together for allowing cutting tool to operate freely. The material is tightened and compressed to a point in which there is no tearing or ripping, This is accomplished the same as said above by pressure applied to the said flange 14 to create the above said tension on material, this is located at the opposite end of the connecting hinge 18 & 34. In the preferred embodiment, this mold is comprised with a continuous groove 40 for a cutting apparatus to penetrate the said material for accurate cutting.

As best shown in FIG. 8 a closing hasp 44 comprised of a right angle for closing the lid 12 at point 26 to the base 30. This provision is made for eliminating the operation and movement of article of manufacture 12 during transporting.

In keeping with one of the principle objects of the invention, FIG. 1 displays a groove 38 to place preferred measuring devise for accurate reading and cut lines.

Both base 30 and lid 12 of said article of manufacture may be made using high strength rigid plastic by means of injection molding or formed a lightweight metal or aluminum. Other acceptable material choices may be apparent for those skilled in the this process of this invention.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An article of manufacture for stabilizing flexible material securely for cutting comprising:
a base and lid comprised of same material with a flat step flange on one end, an operating hinge, a closing hasp, grooves for chosen cutter penetration, and a slot for placing measuring device.

2. The article of manufacture for holding flexible material of claim 1 wherein the base and lid operating members are comprised of a continuous mold, comprised of the same material with an extruding angle that tapers in at top of apparatus to allow material to be stretched and compressed to prevent relative movement.

3. The article of manufacture in claim 2 wherein said base and lid are comprised of a raised center for non surface contact of cutting tool and eliminating hazards of visible blades.

4. The article of manufacture in claim 1 wherein the operable hinge is molded with the same mold as said base and lid members, creating a rigid and durable operating point.

5. The article of manufacture in claim 1 wherein said closing hasp feature comprising of solid substance for closure in which rotates for closure.

6. The article of manufacture in claim 1 wherein the grooves on top of said base and lid are perpendicular to one another to allow cutting tool to penetrate through material to be cut

7. The article of manufacture in claim 6 wherein said cutter grooves conceal blade by penetrating through said base and lid, thus keeping from bodily injury.

8. The article of manufacture in claim 1 wherein said flat end of operating lid member comprising of same mold as lid wide enough for hand or foot stabilization when applying pressure downward to create the opposite pressure on fabric.

9. The article of manufacture in claim 1 wherein said slot is located for placement of measuring devices for accurate measurements and cut lines.
